(19) United States
(12) Patent Application Publication
(10) Pub. No.: US 2006/0244330 A1
(43) Pub. Date: Nov. 2, 2006

(54) Electric machine

(75) Inventor: Wolfgang Hill, Karlsruhe (DE)

Correspondence Address: DAVIDSON, DAVIDSON & KAPPEL, LLC, 485 SEVENTH AVENUE, 14TH FLOOR, NEW YORK, NY, 10018, US

(73) Assignee: LuK Lamellen und Kupplungsbau Beteiligungs KG, Buehl (DE)

(21) Appl. No.: 11/412,319

(22) Filed: Apr. 26, 2006

(30) Foreign Application Priority Data
Apr. 28, 2005 (DE) DE102005019 788.4

(51) Int. Cl. H02K 11/00; H02K 21/12

(52) U.S. Cl. 310/156.05; 310/268; 310/156.35; 310/68 B

(57) ABSTRACT

An electric machine is designed as a disk armature having a secondary part that is rotationally supported about an axis of rotation relative to a primary part. The secondary part has a magnetic disk, which, on its axial end faces, has a circumferentially extending series of alternating, oppositely magnetized, permanent magnetic poles. The magnetic poles interact magnetically with a winding provided on the primary part across at least one air gap disposed axially between the primary part and the secondary part. To sense the position of the secondary part relative to the primary part, a position transducer is provided having at least one magnetic field sensor for detecting the magnetic poles. The magnetic field sensor is located on the primary part in a region on the stator situated radially outside of the magnetic disk.

This claims the benefit of German Patent Application No. 10 2005 019 788.4 filed Apr. 28, 2005 and hereby incorporated by reference herein.

### BACKGROUND

The present invention relates to an electric machine which is designed as a disk armature having a secondary part that is rotationally supported about an axis of rotation relative to a primary part, the secondary part having a magnetic disk, which, on its axial end faces, has a circumferentially extending series of alternating, oppositely magnetized, permanent magnetic poles that interact magnetically with a winding provided on the primary part across at least one air gap disposed axially between the primary part and the secondary part, and having a position transducer for sensing the position of the secondary part relative to the primary part, the position transducer having at least one magnetic field sensor mounted on the primary part, for detecting the magnetic poles. An axis of rotation in this context is understood to be a shaft or an imaginary straight line, about which the primary part and the secondary part are rotatable relative to one another.

An electric machine of this kind, in which the magnetic poles are formed by a shaft-mounted magnetic disk disposed as an intermediate rotor between two stator halves is known in the field. Oppositely magnetized magnetic poles alternate with one another in the circumferential direction. Disposed between the magnetic disk and the stator halves on each of the two sides of the magnetic disk is an air gap which is axially permeated by a magnetic flux. The stator has a soft magnetic core having slots into which coiled windings are wound. Magnetic field sensors for a position transducer provided for sensing the position of the secondary part relative to the primary part, are located in the slots. The winding is electronically commutated via an output stage as a function of a position-measurement signal picked up by the position transducer. The disadvantage associated with the electric machine is that the spatial requirements of the magnetic field sensors necessitate relatively wide slots. Therefore, the electric machine still has relatively large dimensions.

Also known already from the field is an electric machine designed as a disk armature that is not of the species. As a position transducer, it employs a tachogenerator disposed axially next to the arrangement made up of the primary part and the secondary part. The electric machine has relatively long axial dimensions.

### BRIEF SUMMARY OF THE INVENTION

The present invention provides that at least one magnetic field sensor is immovably mounted relative to the stator in a region located radially outside of the magnetic disk.

This advantageously enables the slot openings of the primary part to be relatively narrow in design, thereby making possible compact dimensions of the electric machine. Moreover, since the at least one magnetic field sensor is provided radially outside of the magnetic disk, the electric machine also makes possible a short type of construction. Since the magnetic field sensor is positioned radially on the outside with ample clearance, mounting tolerances of the magnetic field sensor produce only relatively small measurement errors.

In one preferred specific embodiment of the present invention, on both sides of the magnetic disk, on the axial end faces thereof, the secondary part may have magnetically conductive cover plates which have teeth that project beyond the outer surface of the magnetic disk, are each assigned to a magnetic pole, and that, in response to rotation of the secondary part relative to the primary part, rotate past the at least one magnetic field sensor, axially, on both sides. On the one hand, the magnetic disk shields the at least one magnetic field sensor to a certain degree from a magnetic stray field produced by energization of the winding of the primary part, and, on the other hand, a portion of the magnetic flux produced by the magnetic poles of the magnetic disk is selectively directed via the teeth to the magnetic field sensor. When the teeth rotate past the magnetic field sensor, the flux density captured by the sensor changes perceptibly. This change may be evaluated for positional measurement purposes. The thin cover plates are preferably made of a soft magnetic, highly permeable material.

It may be advantageous when, in each case, two teeth, which are assigned to one another in pairs as conjugate teeth, from different cover plates are disposed axially one behind the other. This allows the teeth to be detected with even greater freedom from interference, on the basis of the position-measurement signal, as they rotate past the magnetic field sensor. The tangential width of the teeth may vary. Preferably, however, it corresponds to the pole pitch minus a small slot width or to a fraction of the pole pitch.

One useful embodiment of the present invention may provide for the profile of the at least one cover plate to deviate from a plane, at least in the region of the teeth, and for it to be selected in such a way that the free width between the conjugate teeth is smaller than the clearance space between the cover plates in the region of the magnetic disk. In this case, the at least one magnetic sensor is smaller in thickness than the magnetic disk.

One preferred embodiment of the present invention may provide for at least one discontinuity and/or reduction in the wall thickness of the cover plates in the transition region between two mutually adjacent, opposite magnetic poles of the magnetic disk. In the transition region between mutually adjacent, adjoining magnetic poles, the cover plates then have a higher magnetic resistance than in the middle of the magnetic poles. This reduces the portion of magnetic leakage flux produced by the magnetic disk that flows across the cover plates directly from one magnetic pole to an adjacent magnetic pole having opposite polarity. The cover plates are preferably manufactured in a combined cutting and bending process.

In one advantageous embodiment of the present invention, the discontinuity(ies) and/or reduction(s) may be arranged in such a way that they divide the cover plates into segments. The result is that even less of a magnetic leakage flux occurs between the magnetic poles on the cover plates.

It may be advantageous when the discontinuity is constituted as a radially extending slot and/or as a radially extending perforation. This results in an even further reduction in the magnetic leakage flux flowing across the cover plates. The perforation and/or the slots subdivide the cover plates into segments which are integrally joined in one piece and are each assigned to one magnetic pole. The integrally joined segments are able to be easily mounted on the magnetic disk during manufacture of the electric machine. The cover plates may, of course, also have a multipart design, including a plurality of segments spaced apart circumferentially by intermediate spaces.

In one preferred embodiment of the present invention, at least one tooth may extend in the circumferential direction of the cover plate over the entire width of the segment assigned thereto. A steep-edged change in the magnetic field manifested in a substantial signal excursion then results in the region of the tooth faces when the teeth rotate past the magnetic field sensors. This permits simple and reliable detection of the teeth as they rotate past the magnetic field sensors.

In another advantageous embodiment of the present invention, in the circumferential direction of the cover plate, at least one tooth may have a smaller width than the segment assigned thereto, this tooth preferably being positioned circumferentially in the middle of the segment. This makes it possible to further reduce the magnetic leakage flux on the cover plate.

In one preferred embodiment of the present invention, the cover plates may be made of a soft magnetic alloy, whose saturation flux density is between 10% and 30% above the operating flux density of the magnetic disk. As a result, in the area of the discontinuities, the material of the cover plates saturates relatively early, so that the leakage losses turn out to be correspondingly low.

In one useful embodiment of the present invention, the magnetic disk may have permanent magnets which are embedded in a potting compound, the at least one discontinuity being filled with the potting compound at least in some regions. The permanent magnets and the cover plates are then permanently joined together by the solidified potting compound to form a mechanically stable unit. The potting compound is preferably a potting resin. Together with the cover plates, it forms a corrosion protection for the permanent magnets that is also resistant to any particles present in the air gap.

It may be beneficial when the magnetic disk is designed as an annular disk which is disposed about a carrier part preferably consituted as a shaft or hub member, at least one of the cover plates being nonrotatably connected to the magnetic disk and the carrier part. In response to acceleration and deceleration of the magnetic disk, a portion of the forces of acceleration acting on the magnetic disk are transmitted via the at least one cover plate to the carrier part, thereby reducing the shearing forces in the potting compound correspondingly, in particular in the peripheral zone of the potting compound adjoining the shaft or the hub member. In comparison to an equivalent arrangement without cover plates, this permits a higher torque to be transmitted between the magnetic disk and the carrier part in a manner characterized by long-term stability. The cover plates may be welded, soldered and/or adhesively bonded to the carrier part. The carrier part is preferably made of a nonmagnetic material, for example of high-grade steel, aluminum, brass or of a fiber composite material.

In one preferred embodiment of the present invention, at least one of the cover plates may be designed as an annular disk which, on its inner edge, has a tooth construction, a profiled section that mates with the tooth construction in the sense of a torsionally fixed connection being provided on the carrier part. This enables torques to be transmitted even more efficiently from the magnetic disk to the carrier part. Moreover, the tooth construction renders possible an accurate positioning on the magnetic disk during manufacture of the electric machine. The latter may have a corresponding tooth construction that mates with the profiled section.

It may be advantageous when the cover plates located on both sides of the magnetic disk are identical in design. The cover plates then render possible an especially simple assembly and cost-effective series production.

The wall thickness of the cover plates advantageously may be less than or equal to 0.2 mm, in particular less than or equal to 0.15 mm, and preferably less than or equal to 0.1 mm. As a result, when a magnetic pole rotates past the magnetic field sensor, a magnetic flux is obtained at the magnetic field sensor that suffices for measurement purposes. Nevertheless, only low magnetic losses result in the area permeated by the magnetic flux between the magnetic layer and the stator. Moreover, the relatively thin cover plates make possible a low mass inertia of the secondary part.

### DESCRIPTION OF THE DRAWINGS

Exemplary embodiments of the present invention are explained in greater detail in the following with reference to the drawing, whose figures show:

FIG. 1: a radial section through an electric machine designed as a disk armature;

FIG. 2: a cross-section through the electric machine;

FIG. 3: a plan view of a first exemplary embodiment of a cover plate;

FIG. 4: a plan view of a second exemplary embodiment of a cover plate;

FIG. 5: a partial cross section through a disk armature which includes a magnetic disk without any cover plates;

FIG. 6: a graphic representation of the characteristic curve of a magnetic flux generated in a magnetic field sensor of the disk armature shown in FIG. 5, the rotational position of a secondary part relative to a primary part being plotted on the abscissa, and the magnetic flux being plotted on the ordinate, and a plan view of the corresponding circumferential positions of the secondary part being represented underneath the graphic representation;

FIG. 7: a partial cross section through a disk armature whose cover plates include narrow teeth;

FIG. 8: a representation similar to FIG. 6 for the disk armature shown in FIG. 7;

FIG. 9: a partial cross section through a disk armature whose cover plates have wide teeth; and

FIG. 10: a representation similar to FIG. 6 for the disk armature shown in FIG. 9.

### DETAILED DESCRIPTION

An electric machine designed as a disk armature, denoted as a whole by 1, has a primary part and a secondary part which are rotationally supported relative to one another by friction bearings or rolling-contact bearings 2 about an imaginary axis of rotation 3. The primary part is designed as a stationary stator and the secondary part as a rotor or rotating armature.

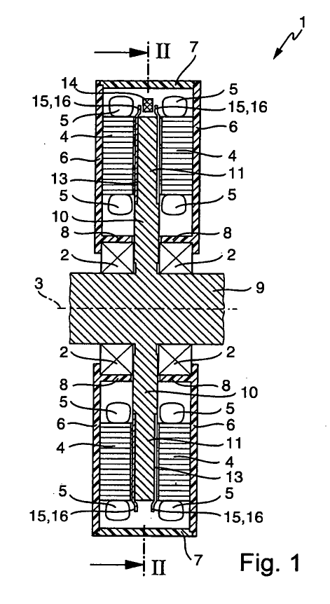

As is readily discernible in FIG. 1, the primary part has two primary part halves, which are disposed on both sides of the secondary part, enclosing the same therebetween. The secondary part is designed as an intermediate rotor. Each primary part half has one soft magnetic stator core 4, which is disposed about axis of rotation 3 and has slots extending radially to axis of rotation 3 that contain coiled windings of a winding 5. The coiled windings project by their winding heads out of the radially inner and outer ends of the slots.

Stator core 4 and winding 5 are located in the interior cavity of a housing having two annular disk-shaped first housing parts 6 which are disposed at the axial end faces of machine 1. At their outer edge, first housing parts 6 are each permanently joined to a peripheral region of a second, approximately cylindrical housing part 7. Second housing part 7 is disposed between first housing parts 6. Integrally formed on the inner side of first housing parts 6 is a web 8, which extends concentrically to axis of rotation 3 and is braced against an outer bearing ring of friction bearing or rolling-contact bearing 2. An inner bearing ring of friction bearing or rolling-contact bearing 2 is mounted on a shaft 9 which traverses the primary part and the secondary part. Located between the bearings constituted of the inner and outer bearing rings and assigned to the individual first housing parts 6, 7 is a hub member 10 which supports an annular magnetic disk 11. Magnetic disk 11 extends in one plane running normally to axis of rotation 3. In the radial section through a plane containing the axis of rotation shown in FIG. 1, it is discernible that hub member 10 is continued in a straight-line prolongation by magnetic disk 11.

Magnetic disk 11 has a plurality of permanent magnets 12, which are uniformly distributed in the circumferential direction of magnetic disk 11, are magnetized in parallel to axis of rotation 3, and which form a number of magnetic poles at the mutually facing axial end faces of magnetic disk 11. In this context, circumferentially adjacent magnetic poles are magnetized in opposite directions; i.e., north and south poles alternate with one another in the circumferential direction. The magnetic poles interact magnetically in a generally known manner with winding 5 across air gaps 13 which are disposed in the axial direction between magnetic disk 11 and stator cores 4.

To sense the position of the secondary part relative to the primary part, electric machine 1 has a position transducer. To detect the magnetic field generated by permanent magnets 12, the position transducer has a plurality of magnetic field sensors 14, each positioned in a straight-line radial prolongation of magnetic disk 11, outside of the same. In FIG. 1, it is clearly discernible that magnetic field sensors 14 are located opposite the outside surface of magnetic disk 11 and are radially spaced apart from the same by a narrow gap. It is also discernible that magnetic field sensors 14 are positioned on the inside of second housing part 7; thus they are fixed relative to the stator. Magnetic field sensors 14 are mounted on a ceramic platelet that is located on second housing part 7 and that efficiently thermoconductively connects magnetic field sensors 14 to second housing part 7. The dissipation heat produced in the winding heads is distributed in the radially outer winding heads of the winding over a larger surface area than in the radially inner winding heads. As a result, and due to the efficient dissipation of heat to the housing, the thermal loading of magnetic field sensors 14 is negligible.

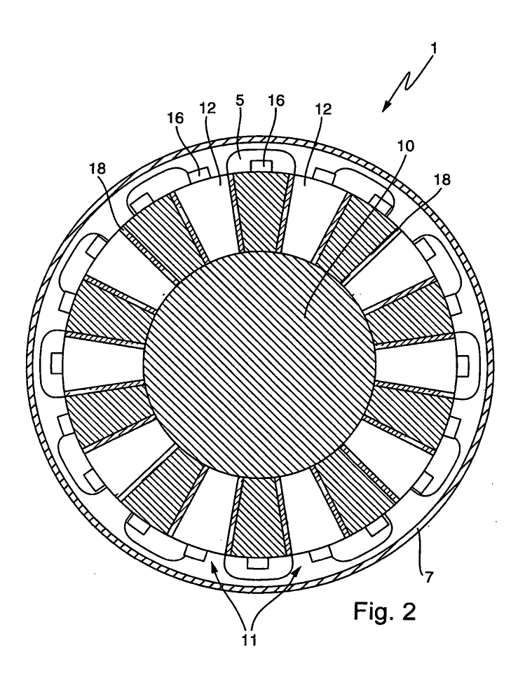

In the exemplary embodiments shown in FIG. 1 through 3 and 7 through 9, on both sides of magnetic disk 11, on each of its axial end faces, the secondary part has an annular disk-shaped, magnetically conductive cover plate 15 located directly on magnetic disk 11. In FIG. 2, it is discernible that cover plates 15 have teeth 16 which project radially beyond the outer surface of magnetic disk 11, are each assigned to a magnetic pole, and which are each positioned circumferentially approximately in the middle of the respective magnetic pole. The projecting length of the teeth is only a few millimeters, preferably even less than one millimeter.

In each case, the conjugate teeth from different cover plates 15 are disposed axially one behind the other. Conjugate teeth 16 each have a different magnetic polarity, so that the intermediate space formed between them is permeated by a portion of the magnetic flux produced by permanent magnets 12 adjacent thereto, substantially in parallel to axis of rotation 3. In response to rotation of the secondary part relative to the primary part, conjugate teeth 16 rotate axially past magnetic field sensors 14, on both sides.

In FIG. 1, it is discernible that teeth 16 each exhibit a step-shaped profile starting out from their unattached end, continuing radially toward the axis of rotation. In this context, the free width between the mutually assigned and mutually axially opposing teeth 16 is smaller than the axial clearance space between cover plates 15 in the region of magnetic disk 11.

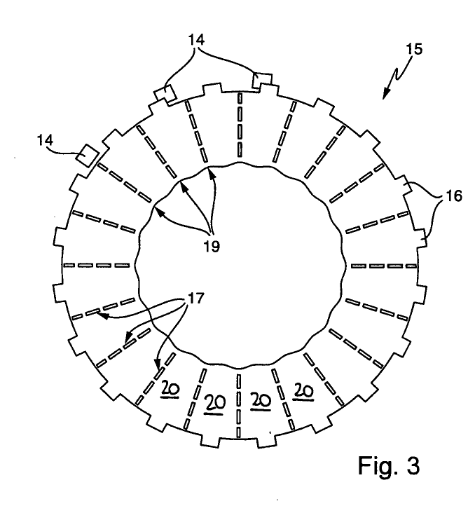

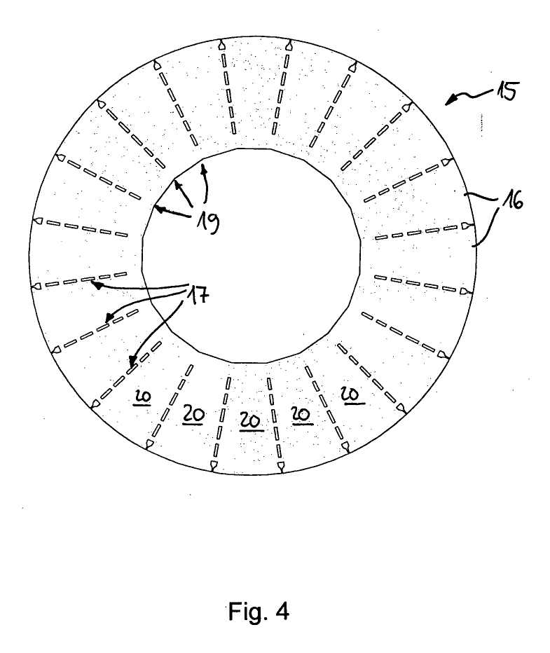

In FIGS. 3 and 4, it is discernible that the cover plates have perforations 17 which correspond in number to the magnetic poles, extend radially to axis of rotation 3, and are spaced apart circumferentially by unperforated regions. Perforations 17 each have a plurality of slots which are disposed radially one behind the other and whose longitudinal extension runs approximately radially. Perforations 17 are each provided between circumferentially mutually adjacent permanent magnets 12. Perforations 17 subdivide cover plates 15 into segments 20 which are integrally joined in one piece. Perforations 17 each terminate at a distance from the inner edge of the approximately annular disk-shaped cover plates 15. This ensures a good mechanical connection between the segments. Starting from the outer edge of cover plates 15 along the perforation and its straight-line extension toward the inner edge of cover plates 15, the leakage losses increase somewhat due to the lack of perforation there. Since excess flux is produced in the radial inner region of the stator cores when working with slots having a constant slot width, and due to the smaller torque-producing leverage effect, this increase in leakage flux is knowingly accepted.

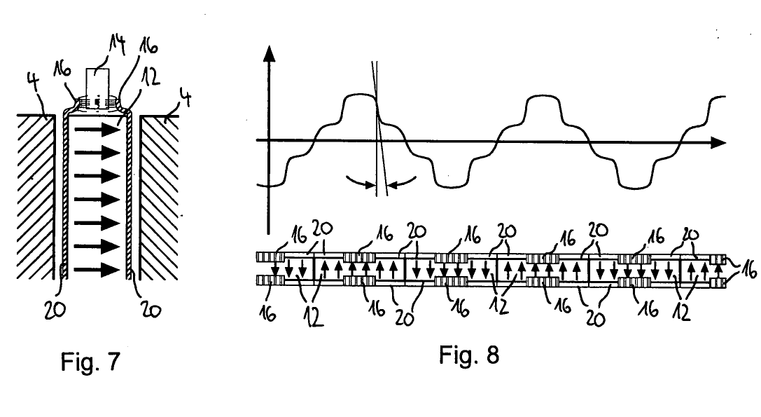

In the exemplary embodiment in accordance with FIGS. 3 and 7, in the circumferential direction of cover plate 15, each of teeth 16 are smaller in width than segments 20 on which teeth 16 are located. In the circumferential direction of cover plate 15, individual teeth 16 are disposed approximately centrally with respect to segment 20. As is discernible in FIG. 8, in response to a relative motion between the primary part and the secondary part, a rapid change in the magnetic flux is produced at magnetic field sensors 14 by teeth 16 as the magnetic poles rotate past magnetic field sensors 14.

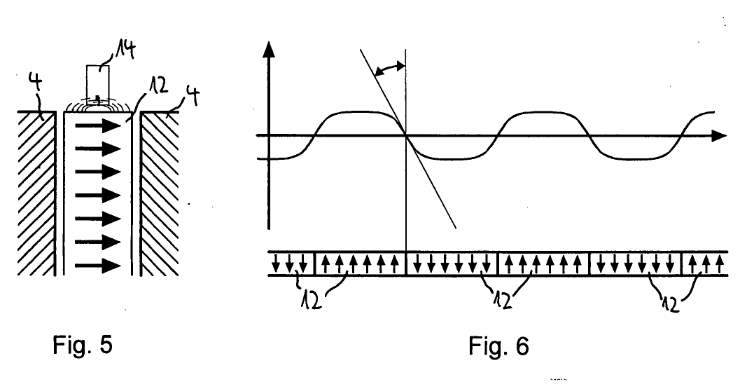

In the exemplary embodiment shown in FIG. 5, the secondary part does not have any magnetic disk. A comparison of FIG. 6 and FIG. 8 reveals that the magnetic flux density in this exemplary embodiment exhibits a less pronounced steepness of the edge gradient than in the secondary part having the toothed magnetic disk.

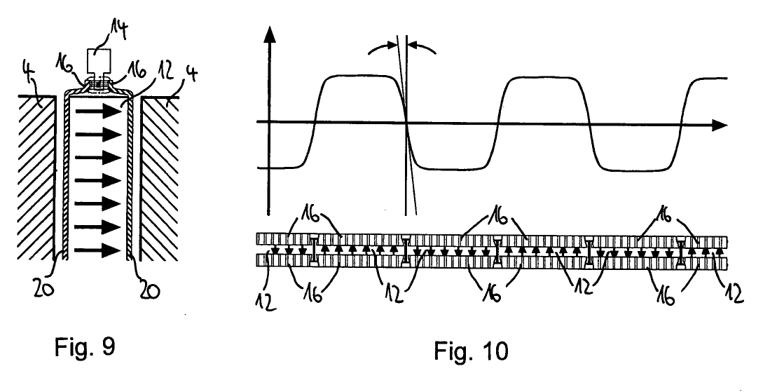

In the exemplary embodiment shown in FIGS. 4 and 9, in the circumferential direction of cover plate 15, each of teeth 16 extend over the entire width of segment 20 on which they are located. This results in an even greater steepness of the edge gradient of the magnetic flux density at magnetic field sensors 14. A comparison of FIG. 8 and FIG. 10 reveals that the larger sensor width produces a greater signal excursion in the magnetic flux density in the region of the pole transitions. As a result, magnetic field sensors 14 may have a higher switching threshold than in the exemplary embodiments in FIGS. 3, 5 and 7. It should also be mentioned that, in the exemplary embodiment in accordance with FIG. 9, magnetic field sensors 14 have a smaller wall thickness in a region that engages between teeth 16 than in a region located outside of teeth 16. The housing of magnetic field sensors 14 features a step or a shoulder on both sides, between the region having the smaller wall thickness and the region having the large wall thickness.

The two cover plates 15 are identical in design and are made of a soft magnetic alloy whose saturation flux density is between 10% and 30% above the operating flux density of permanent magnets 12. Cover plates 15 are made of a nickel-iron alloy having a saturation flux density of about 1.1 T. Permanent magnets 12 made of a sintered neodymium-iron-boron alloy have a remanence of about 1.3 T, and their operating point is at approximately 0.95 T. Thus, the narrow webs provided between the slots of perforations 17 are already saturated at 1.1 T, so that the leakage losses are minimal. Due to the high magnetic permeability of cover plates 15 in the region of the operating flux density, the magnetic resistance of the main field remains at a low level and the air-gap flux density at a high level, thereby permitting a high performance density of the disk armature.

The wall thickness of cover plates 15 fabricated in a combined cutting and bending process is approximately 0.1 mm. At least one small slot (not shown in detail in the drawing) may be optionally provided in the root region of teeth 16 in order to weaken eddy currents induced in teeth 16 by winding 5.

The permanent magnets are embedded between cover plates 15 in a solidified potting compound which engages positively into perforations 17.

In the exemplary embodiment shown in FIG. 3, on their radially inner edge, cover plates 15 have a tooth construction 19 which mates with a profiled section (not shown in detail in the drawing) provided on the outer surface of hub member 10. With the aid of the profiled section and tooth construction 19, the rotor made up of magnetic disks 11 and cover plates 15 is connected nonrotatably to hub member 10.

### REFERENCE NUMERALS

1 electric machine
2 friction bearing or rolling-contact bearing
3 axis of rotation
4 stator core
5 winding
6 first housing part
7 second housing part
8 web
9 shaft
10 hub member
11 magnetic disk
12 permanent magnet
13 air gap
14 magnetic field sensor
15 cover plate
16 tooth
17 perforation
18 potting compound
19 tooth construction
20 segment

What is claimed is:

1. An electric machine comprising:
a disk armature having a primary part having a stator with a winding and a secondary part rotationally supported about an axis of rotation relative to the primary part, the secondary part having a magnetic disk having axial end faces, the magnetic disk having a circumferentially-extending series of alternating, oppositely magnetized, permanent magnetic poles interacting magnetically with the winding across at least one air gap disposed axially between the primary part and the secondary part; and
a position transducer for sensing a position of the secondary part relative to the primary part, the position transducer having at least one magnetic field sensor for detecting the magnetic poles, the at least one magnetic field sensor being fixedly mounted relative to the stator in a region radially outside of the magnetic disk.

2. The electric machine as recited in claim 1 wherein, on both sides of the magnetic disk, on the axial end faces thereof, the secondary part has magnetically conductive cover plates on the magnetic disk projecting radially beyond an outer surface of the magnetic disk.

3. The electric machine as recited in claim 2 wherein the magnetically conductive cover plates form teeth, each assigned to a magnetic pole and projecting radially beyond the outer surface, the teeth, in response to rotation of the secondary part relative to the primary part, rotating past the at least one magnetic field sensor, axially, on both sides, and, in each case, two teeth assigned to one another in pairs from different cover plates are disposed axially one behind the other.

4. The electric machine as recited in claim 2 wherein a profile of the at least one cover plate deviates from a plane, at least in a region of the teeth so that a free width between conjugate teeth on each of the cover plates is smaller than the clearance space between the cover plates in the region of the magnetic disk.

5. The electric machine as recited in claim 2 wherein, in a transition region between two mutually adjacent, opposite magnetic poles of the magnetic disk, the cover plates have at least one discontinuity and/or a reduction in the wall thickness thereof.

6. The electric machine as recited in claim 5 wherein the at least one discontinuity and/or reduction is arranged to divide the cover plates into segments.

7. The electric machine as recited in claim 5 wherein the discontinuity is constituted as a radially extending slot and/or as a radially extending perforation.

8. The electric machine as recited in claim 6 wherein at least one tooth of the cover plate extends in the circumferential direction of the cover plate over an entire width of the segment assigned thereto.

9. The electric machine as recited in claim 2 wherein, in the circumferential direction of the cover plate, at least one tooth has a smaller width than the segment assigned thereto, and this tooth is preferably positioned circumferentially in the middle of the segment.

10. The electric machine as recited in claim 2 wherein the cover plates are made of a soft magnetic alloy whose saturation flux density is between 10% and 30% above the operating flux density of the magnetic disk.

11. The electric machine as recited in claim 1 wherein the magnetic disk has a potting compound, the permanent magnets being embedded in the potting compound, and the magnetic disk has at least one discontinuity filled with the potting compound.

12. The electric machine as recited in claim 2 wherein the magnetic disk is designed as an annular disk which is disposed about a carrier part constituted as a shaft or hub member, and at least one of the cover plates is nonrotatably connected to the magnetic disk and the carrier part.

13. The electric machine as recited in claim 2 wherein at least one of the cover plates is designed as an annular disk which, on its inner edge, has a tooth construction, a profiled section that mates with the tooth construction in the sense of a torsionally fixed connection, being provided on the carrier part.

14. The electric machine as recited in claim 2 wherein the cover plates arranged on both sides of the magnetic disk are identical in design.

15. The electric machine as recited in claim 2 wherein the wall thickness of the cover plates is less than or equal to 0.2 mm, in particular less than or equal to 0.15 mm, and preferably less than or equal to 0.1 mm.

16. The electric machine as recited in claim 1 wherein the magnetic field sensor measures a magnetic field component that is directed in parallel to the axis of rotation.
